(19) United States
(12) Patent Application Publication
(10) Pub. No.: US 2015/0130369 A1
(43) Pub. Date: May 14, 2015

(54) POWER SUPPLY SYSTEM OF ONE OR MORE LIGHTING MODULES WITH LIGHT-EMITTING DIODES, ASSOCIATED LIGHTING SYSTEM AND ASSOCIATED POWER SUPPLY METHOD

(71) Applicant: SCHNEIDER ELECTRIC INDUSTRIES SAS, Rueil-Malmaison (FR)

(72) Inventors: Jean-Louis LOVATO, Biviers (FR); Dominique Persegol, Grenoble (FR); Alain Dentella, Beaucroissant (FR)

(73) Assignee: SCHNEIDER ELECTRIC INDUSTRIES SAS, Rueil-Malmaison (FR)

(21) Appl. No.: 14/532,340

(22) Filed: Nov. 4, 2014

(30) Foreign Application Priority Data
Nov. 12, 2013 (FR) 13 61014

(51) Int. Cl. H05B 33/08

(52) U.S. Cl. CPC H05B 33/08
USPC 315/294

(57) ABSTRACT

The inventive power supply system (8) for one or more lighting modules (6a, 6b, 6c) with light-emitting diodes comprises an electrical power source (14) able to be connected to the or each lighting module (6a, 6b, 6c) via an electrical connection (16a, 16b, 16c) and a detection device (22) for detecting a connection direction of the or each lighting module (6a, 6b, 6c).

The detection device (22) comprises, for the or each lighting module, injection means (50) for injecting a setpoint current, first comparison means (52) for comparing a voltage measured on the corresponding electrical connection (16a, 16b, 16c) following the injection of the setpoint with a first voltage threshold, and inversion means (54) for inverting the polarity of the lighting module (6a, 6b, 6c) when the voltage measured on the corresponding electrical connection (16a, 16b, 16c) is greater than or equal to the first voltage threshold.

When the voltage measured on the corresponding electrical connection (16a, 16b, 16c) is greater than or equal to the first voltage threshold (S1) for the direct and inverse polarities of the lighting module (6a, 6b, 6c), the first comparison means (52) are capable of incrementing the first voltage threshold by a reference value for one or more future comparisons of said voltage with the first voltage threshold.

The present invention relates to a power supply system for one or more lighting modules with light-emitting diodes, a set of light-emitting diodes including one or more such lighting modules and a power supply system, as well as a method for powering the lighting module(s) using such a power supply system.

The or each lighting module comprises at least one light-emitting diode and can be polarized using a direct polarity or an inverse polarity depending on the direction in which it is connected to the power supply system. The light-emitting diode(s) are polarized in direct mode for the direct polarity of the lighting module, and in the inverse mode, respectively, for the inverse polarity of the lighting module.

In the field of the power supply for lighting modules with light-emitting diodes, it is known to use power supply systems that make it possible to group several electrical connections together in the same housing for powering a plurality of lighting modules. The power supply of the lighting modules is thus centralized and the connection of the lighting modules to the power supply system is simplified. However, during the installation of such power supply systems, it is generally necessary for an operator to know and respect the polarity of the light-emitting diode(s) of the lighting modules in order to connect them to the power supply system. Furthermore, each lighting module must be connected to a predetermined electrical power supply connection. Moreover, the power necessary to power the lighting modules must be known and allocated to the corresponding electrical power supply connections. It therefore appears that such power supply systems for lighting modules with light-emitting diodes are complex to implement, in particular when there is a large number of lighting modules.

Furthermore, known from document EP-A1-2,464,198 is a power supply system for one or more lighting modules with light-emitting diodes making it possible to connect the lighting module(s) to the power supply system, without taking the polarity of the light-emitting diode(s) into account. In fact, this power supply system comprises means for detecting the connection direction of the lighting module(s), making it possible to determine the direction of the current to be delivered to the or each lighting module, in order to polarize its light-emitting diode(s) in the direct direction. In such a system, in order to detect the connection direction, a current pulse is transmitted to the corresponding lighting module so as to flow in a first direction, then in a second direction through that module. However, such a system may create a risk of destruction of said light-emitting diode(s) and therefore of the corresponding lighting module. This risk is even higher with organic light-emitting diodes (OLED), which are particularly fragile and sensitive to excesses of their rated current and voltage values.

The aim of the invention is therefore to propose a power supply system for one or more lighting modules, which are easy to install and make it possible to simplify the connection of the lighting module(s) to the power supply system, without any risk of destruction of the lighting module(s).

To that end, the invention relates to a power supply system for one or more lighting modules with light-emitting diodes, the or each lighting module comprising at least one light-emitting diode and being able to be polarized depending on its connection direction according to a direct polarity or an inverse polarity, the light-emitting diode(s) being polarized in direct mode for the direct polarity of the lighting module and in inverse mode, respectively, for the inverse polarity of the lighting module,

the system including:
an electrical power source able to be connected to the or each lighting module via an electrical connection for the or each lighting module,
a first measuring device for measuring, on the or each electrical connection, a voltage delivered to the corresponding lighting module and a second measuring device for measuring, on the or each electrical connection, a current delivered to the corresponding lighting module,
a detection device for detecting a connection direction of the or each lighting module comprising, for the or each lighting module, injection means for injecting a setpoint current on the corresponding electrical connection, first comparison means for comparing with a first voltage threshold, the voltage measured on the corresponding electrical connection following the injection of the setpoint current and inversion means for inverting the polarity of the lighting module when the voltage measured on the corresponding electrical connection is greater than or equal to the first voltage threshold.

According to the invention, the voltage measured on the corresponding electrical connection is greater than or equal to the first voltage threshold for the direct and inverse polarities of the lighting module, and the first comparison means are capable of incrementing the first voltage threshold by a reference value for one or more future comparisons of said voltage with the first voltage threshold.

Owing to the invention, when the connection direction of the or each lighting module is detected, the voltage delivered on the corresponding electrical connection is measured, and the direction of the current flowing through the lighting module is inverted when the measured voltage exceeds the first voltage threshold. The power supply system thus makes it possible to limit the voltage across the terminals of the or each lighting module when the connection direction of the or each lighting module is detected, and thus to protect the or each lighting module from any destruction due to the application of an excessively high voltage across its terminals, in particular when the light-emitting diodes are polarized in the inverse mode.

According to other aspects of the invention, the power supply system comprises one or more of the following features, considered alone or according to all technically possible combinations:
the detection device comprises, for the or each lighting module, second comparison means for comparing the intensity of the current measured on the corresponding electrical connection with a current threshold, the second comparison means being able to detect the direct polarity of the lighting module when the measured intensity is above the current threshold;
for the or each lighting module, the injection means are able, upon each change in polarity of the lighting module, to inject the setpoint current in order to increasingly vary the voltage delivered to the lighting module, between a second voltage threshold and a maximum voltage, the value of the first voltage threshold being comprised between that of the second voltage threshold and that of the maximum voltage;
the detection device comprises storage means for the or each lighting module, for the value of the voltage measured by the first measuring device, when the intensity of the current measured by the second measuring device is greater than the current threshold, the stored value corresponding to a minimum operating voltage of the corresponding lighting module.

The invention also relates to a lighting assembly with light-emitting diodes including one or more lighting modules with light-emitting diodes and a power supply system as defined above.

According to other advantageous aspects of the invention, the assembly further comprises one or more of the following features, considered alone or according to any technically admissible combinations:
the assembly comprises several lighting modules, while the power supply system comprises a control member for the electrical power supply capable of successively powering each electrical connection, the control member comprising identification means for the electrical connection associated with each lighting module;
the assembly further comprises a configuration module for the power supply system, the configuration module comprising means for backing up a configuration file, the configuration file including configuration parameters for each lighting module, whereas following the identification of each electrical connection, the configuration module is able to download the configuration parameters into the control member and associate them with the corresponding electrical connection;
for each lighting module, the power supply system comprises first computation means for computing an instantaneous consumed power, while the first computation means are able to send the control member the instantaneous powers computed for each electrical connection, and whereas the control member comprises a second computation means for computing a remaining available power based on the instantaneous consumed powers, and allocation means for allocating power to the various electrical connections.

The invention also relates to a power supply method for one or more lighting modules with light-emitting diodes using a power supply system, the or each lighting module comprising at least one light-emitting diode and being able to be polarized using a direct polarity or an inverse polarity depending on its connection direction, the light-emitting diodes(s) being polarized in direct mode for the direct polarity of the lighting module, and in inverse mode, respectively, for the inverse polarity of the lighting module, the system including an electrical power supply able to be connected to the or each lighting module via an electrical connection for the or each lighting module, a first measuring device for measuring a voltage delivered to the corresponding lighting module on the or each electrical connection, a second measuring device for measuring a current delivered to the corresponding lighting module on the or each electrical connection, and a detection device for detecting a connection direction of the or each lighting module,

the method comprising, for the or each lighting module, the following steps:
a) using the detection device to inject a setpoint current on the corresponding electrical connection,
b) measuring the voltage delivered to the lighting module,
c) comparing the measured voltage with a first voltage threshold, during the measuring step,
d) inverting the polarity of the corresponding lighting module, when the voltage measured on the corresponding electrical connection is greater than or equal to the first threshold voltage, and returning to the injection step.

According to the invention, the method further comprises, for the or each lighting module, the following step:
e) when said voltage is greater than or equal to the first voltage threshold for the direct and inverse polarities of the lighting module, incrementing the first voltage threshold by a reference value, for one or more future comparisons of the voltage measured on the corresponding electrical connection with the first voltage threshold.

According to other advantageous aspects of the invention, the method further comprises one or more of the following features, considered alone or according to all technically acceptable combinations:
for the or each lighting module, the method comprises the following steps before the step for measuring the voltage:
   a1) measuring the current circulating in the corresponding electrical connection,
   a2) comparing the intensity measured in the corresponding electrical connection with a current threshold,

and whereas after the intensity comparison step, if the measured intensity is greater than or equal to the current threshold, the method further comprises the following step:
a3) detecting the direct polarity of the lighting module;
during the injection step, the setpoint current is injected to cause the voltage delivered to the lighting module to vary increasingly, between a second voltage threshold and a maximum voltage, the value of the first voltage threshold being comprised between that of the second voltage threshold and that of the maximum voltage.

The invention will be better understood and other advantages thereof will appear more clearly in light of the following description, provided solely as a non-limiting example, and done in reference to the drawings, in which:

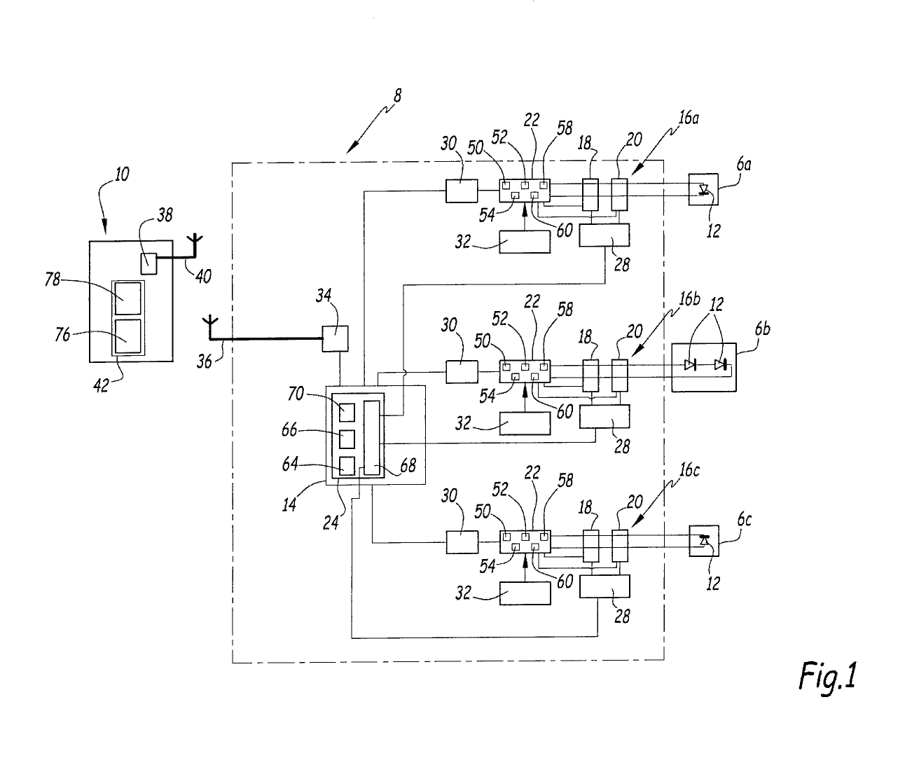

FIG. 1 is a diagrammatic illustration of a lighting assembly with light-emitting diodes according to the invention, the assembly including first, second and third lighting modules with light-emitting diodes, and a power supply system for powering the lighting modules via three electrical connections;

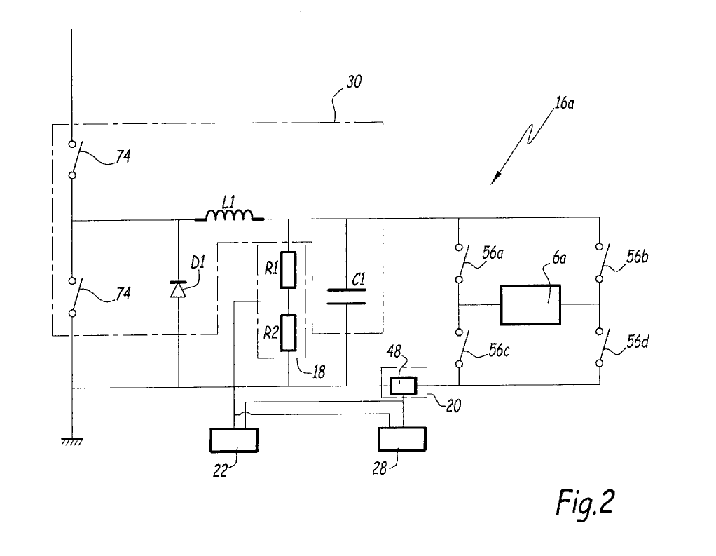

FIG. 2 is a very diagrammatic illustration of an electrical connection of the power supply system of FIG. 1, to which the first lighting module with light-emitting diodes is connected;

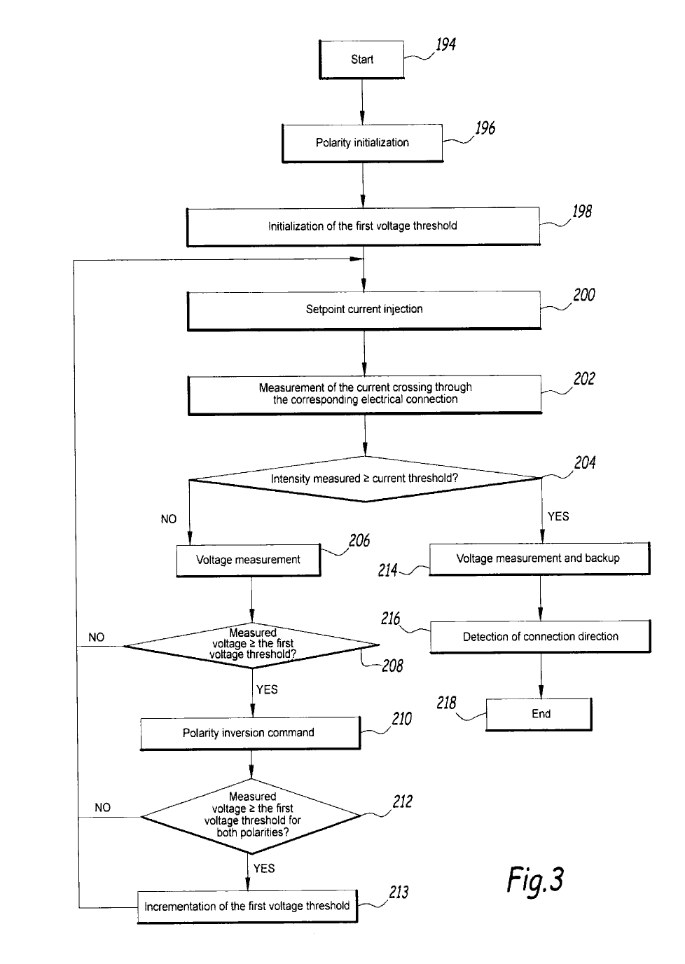

FIG. 3 is a flowchart of a power supply method for the lighting modules of FIG. 1 according to a first embodiment of the invention; and

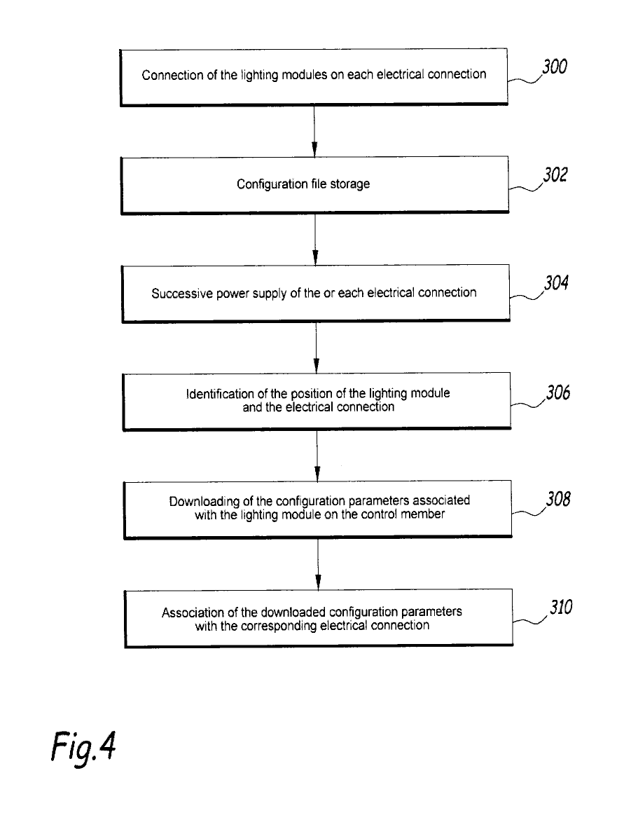

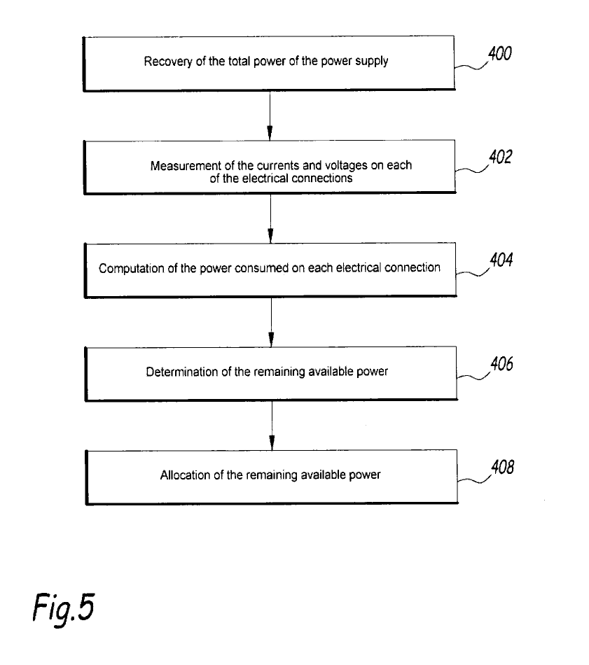

FIGS. 4 and 5 are views similar to that of FIG. 3 according to a second and third embodiment of the invention, respectively.

In FIG. 1, a lighting assembly 4 with light-emitting diodes comprises first 6a, second 6b and third 6c lighting modules with light-emitting diodes, a power supply system 8 for the lighting modules 6a, 6b, 6c, and a configuration module 10 for the power supply system 8.

The lighting modules 6a, 6b, 6c each comprise one or more light-emitting diodes 12 able to be polarized in a direct polarity or an inverse polarity depending on their connection direction. More specifically, in FIG. 1, the first lighting module 6a comprises a light-emitting diode 12 connected in a first direction, the second lighting module 6b comprises two light-emitting diodes 12 connected in series and connected in the first direction, and the third lighting module 6c comprises a light-emitting diode 12 connected in a second direction, opposite the first direction. Each lighting module 6a, 6b, 6c is in a direct polarity when the corresponding light-emitting diode(s) 12 are directly polarized, respectively in an inverse polarity when the corresponding light-emitting diode(s) 12 are polarized in the inverse mode.

The power supply system 8 comprises an electrical power supply source 14 able to be connected to each lighting module 6a, 6b, 6c via a respective electrical connection 16a, 16b, 16c. The power supply system 8 also comprises, for each lighting module 6a, 6b, 6c, a first measuring device 18 for measuring a voltage on the corresponding electrical connection 16a, 16b, 16c, a second measuring device 20 for measuring the intensity of the current delivered to the lighting module 6a, 6b, 6c on the corresponding electrical connection 16a, 16b, 16c, and a detection device 22 for detecting a connection direction of the lighting module 6a, 6b, 6c.

The power supply system 8 comprises a control member 24 for the electrical power supply source 14 and, for each electrical connection 16a, 16b, 16c, a first software application 28 for computing an instantaneous power consumed by each lighting module 6a, 6b, 6c. The power supply system 8 comprises, for each electrical connection 16a, 16b, 16c, a module 30 for steering the electrical power delivered on each electrical connection 16a, 16b, 16c and an allocation device 32 for allocating polarity to the corresponding lighting module 6a, 6b, 6c.

The power supply system 8 also comprises a first wireless transceiver 34 and a first wireless antenna 36.

The configuration module 10 includes a second wireless transceiver 38, a second wireless antenna 40 and a processing unit 42.

Each wireless connection 16a, 16b, 16c is able to deliver, owing to the electric power supply source 14, a current and a voltage to the corresponding lighting module 6a, 6b, 6c.

Each first measuring device 18 is able to measure the voltage delivered to the corresponding lighting module 6a, 6b, 6c on the corresponding electrical connection 16a, 16b, 16c. Each first measuring device 18 for example comprises, as shown in FIG. 2, two resistances R1, R2 connected in parallel with the corresponding lighting module 6a, 6b, 6c, the measured voltage being recovered between the two resistances R1, R2 and sent to the detection device 22 in the first computation software 28.

Each second measuring device 20 is able to measure the current delivered to the corresponding lighting module 6a, 6b, 6c on the corresponding electrical connection 16a, 16b, 16c. Each second measuring device 20 for example comprises a shunt 48 able to measure the intensity of the current crossing through it and send the measured intensity to the first computation software 28 and the detection device 22.

Each detection device 22 comprises injection means 50 for injecting a setpoint current on the corresponding electrical connection 16a, 16b, 16c. Each detection device 22 comprises first comparison software 52, for comparing the voltage measured by the first measuring device 18 on the corresponding electrical connection 16a, 16b, 16c, following the injection of the setpoint by the injection means 50, to a first voltage threshold S1. The detection device 22 comprises inversion means 54 for inverting the polarity of the corresponding lighting module 6a, 6b, 6c, when the voltage measured on the corresponding electrical connection 16a, 16b, 16c is greater than or equal to the first voltage threshold S1. The first voltage threshold 51 is for example comprised between 3 Volts (V) and 50 V.

Each detection device 22 also comprises, for the corresponding lighting module 6a, 6b, 6c, second software 58 for comparing the intensity measured on the corresponding electrical connection 16a, 16b, 16c with a current threshold A1. The current threshold A1 is for example comprised between 20 mA and 50 mA. More specifically, the current threshold A1 is for example equal to the current reference value.

Each detection device 22 includes, for the corresponding lighting module 6a, 6b, 6c, software 60 for storing a value of the voltage measured by the corresponding first measuring device 18, when the intensity measured by the corresponding second measuring device 20 is above the current threshold A1. The stored value corresponds to a minimum operating voltage of the corresponding lighting module 6a, 6b, 6c.

The control member 24 is able to control the power supply of each electrical connection 16a, 16b, 16c successively. The control member 24 comprises software 64 for identifying the electrical connection 16a, 16b, 16c associated with each lighting module 6a, 6b, 6c and first software 66 for downloading configuration parameters on the corresponding steering module 30. The configuration parameters for example correspond to the rated voltage and the rated operating voltage of each lighting module 6a, 6b, 6c, i.e., a current and a voltage corresponding to an optimal operation of said lighting module 6a, 6b, 6c.

The control member 24 also comprises second software 68 for computing the remaining available power based on the instantaneous powers consumed by each lighting module 6a, 6b, 6c and computed by each first computation software 28. The second computation software 68 is also suitable for computing a maximum power that can be delivered by the electrical power supply 14. The control member 24 includes software 70 for allocating power to the different electrical connections 16a, 16b, 16c, i.e., to the different lighting modules 6a, 6b, 6c.

Each steering module 30 can distribute the power allocated by the allocation software 70 to the corresponding electrical connection 16a, 16b, 16c. Each control module 30 can also be controlled via the injection means 50 of the setpoint current, in order to deliver said setpoint current to the corresponding lighting module 6a, 6b, 6c.

Each steering module 30 comprises, as shown in FIG. 2, two control switches 74 for controlling the current and voltage delivered by the electrical power supply 14 on the corresponding electrical connection 16a, a diode D1 for protecting against overvoltages, a coil L1 capable of supplying current to the corresponding lighting module 6a and a capacitor C1 connected in parallel with the lighting module 6a.

The allocation device 32 is able, depending on the connection direction detected by the detection device 22, to set the polarity of the corresponding lighting module 6a, 6b, 6c, so that the latter is always in a direct polarity and its light-emitting diode(s) 12 light around them.

The first transceiver 34 and the first antenna 36 can exchange data with the second wireless transceiver 38 and the second wireless antenna 40. More specifically, the configuration module 10 and the power supply system 8 are able to communicate via the first 36 and second 40 wireless antennas and the first 34 and second 38 wireless transceivers.

The processing unit 42 comprises software 76 for backing up a configuration file including the configuration parameters for each lighting module 6a, 6b, 6c. The processing unit 42 also comprises second downloading software 78 capable of downloading the configuration parameters corresponding to the lighting module 6a, 6b, 6c whereof the light-emitting diode(s) 12 are powered into the control member 24, when the control member 24 controls the power supply for each electrical connection 16a, 16b, 16c successively.

The injection means 50 are able, upon each change in polarity of the corresponding lighting module 6a, 6b, 6c, to inject the setpoint current, in order to increase the voltage delivered to the corresponding lighting module 6a, 6b, 6c. More specifically, the voltage varies between a second voltage threshold S2 and a maximum voltage Umax. The value of the first voltage threshold S1 is comprised between that of the second voltage threshold S2 and that of the maximum voltage Umax. The second voltage threshold S2 is for example equal to 0.3 V, and the maximum voltage Umax is for example equal to 50 V. More specifically, as shown in FIG. 2, the injection means 50 are able to vary the voltage across the terminals of the capacitor C1, and thus to increase the voltage delivered to the corresponding lighting module 6a, until that voltage is sufficient to power the corresponding light-emitting diode 12 or the first voltage threshold S1 is reached.

Each first comparison software application 52 is able, when the voltage measured on the corresponding electrical connection 16a, 16b, 16c is greater than or equal to the first voltage threshold S1 for the direct and inverse polarities of the corresponding lighting module 6a, 6b, 6c, to increase the first voltage threshold S1 by a reference value for the next comparison(s) of the measured voltage to the first voltage threshold S1.

The inversion means 54 for example include four controllable switches 56a, 56b, 56c, 56d that can, depending on their position, modify the direction of a current passing through the corresponding lighting module 6a, 6b, 6c, as shown in FIG. 2. More generally, the inversion means 54 are as shown in FIG. 3 and paragraph [0025] patent application EP-A1-2,464,198.

The identification software 64 is able to identify the electrical connection 16a, 16b, 16c associated with each lighting module 6a, 6b, 6c. More specifically, during the successive control of the power supply of each electrical connection 16a, 16b, 16c, the identification software 64 can identify the electrical connections 16a, 16b, 16c supplied with electricity.

The downloading software 66 is able to download, onto the control module 30 corresponding to the electrical connection 16a, 16b, 16c identified by the identification software, the configuration parameters downloaded on the control member 24 via the second downloading software 78.

The second computation software 68 computes the remaining available power based on the instantaneous powers consumed, computed by the first computation software 28, and the maximum power that the electrical power supply 14 can provide.

The allocation software 70 is able to allocate electrical power to each lighting module 6a, 6b, 6c. The allocation software 70 is for example able to carry out an allocation and distribution strategy for the electrical power delivered by the electricity supply means 14 between the lighting modules 6a, 6b, 6c. Said allocation and distribution strategy is, for example, stored by the control member 24.

Additionally, in the context of an installation and successive connection of the lighting modules 6a, 6b, 6c to the power supply system 8, i.e., the electrical connections 16a, 16b, 16c, the second computation software 68 is able to compute the remaining available power following connection of one of the lighting modules 6a, 6b, 6c to the power supply system 8.

Thus, the control member 24 is able to send the configuration module 10 the available remaining power, and the display member, not shown, allows an operator, following each connection of one of the lighting modules 6a, 6b, 6c to the corresponding electrical connection 16a, 16b, 16c, to determine the remaining available power and to define the power to be allocated to the next lighting module(s) 6a, 6b, 6c to be connected to the electrical connections 16a, 16b, 16c.

When the control member 24 commands the power supply of each electrical connection 16a, 16b, 16c, successively, the operator is able to identify the lighting module 6a, 6b, 6c for which the light-emitting diodes are powered on and light around them. The second downloading means 78 are then able to send the first downloading software 66 the configuration parameters corresponding to the lighting module 6a, 6b, 6c identified by the operator.

Three embodiments of a method for powering on the lighting modules 6a, 6b, 6c using the power supply system 8 will be described below.

The power supply method shown in FIG. 3 is according to a first embodiment and is applicable to each lighting module 6a, 6b, 6c. The power supply method according to the first embodiment comprises a first starting step 194, i.e., for launching an algorithm corresponding to the method and applying the algorithm to the corresponding lighting module 6a, 6b, 6c.

Then, during the step 196 for initializing polarity, the polarity of the corresponding lighting module 6a, 6b, 6c is set, and the corresponding lighting module 6a, 6b, 6c has a first polarity, called default polarity. The default polarity corresponds to a predetermined state of the switches 56a, 56b, 56c, 56d. More specifically, the default polarity corresponds either to a closed position of switches 56a and 56d and an open position of the switches 56b and 56c, or a closed position of the switches 56b and 56c and an open position of the switches 56a and 56d.

Next, during step 198, the value of the first voltage threshold S1 is initialized. More specifically, the value of the first threshold voltage S1 is for example set at 5 V.

Then, the method comprises a step 200 consisting of the injection, by the detection device 22, and more specifically by the injection means 50, of the setpoint current on the corresponding electrical connection 16a, 16b, 16c. The setpoint current is injected in order to increasingly vary the voltage delivered to the corresponding lighting module 6a, 6b, 6c, between the second voltage threshold S2 and the maximum voltage Umax.

Following the injection step 200, the intensity of the current crossing through the corresponding second measuring device 20 is measured during a step 202.

During a following step 204, the intensity measured on the corresponding electrical connection is compared with the current threshold A1.

Next, if the intensity measured during step 204 is below the current threshold A1, the first measuring device 18 then measures the voltage delivered to the corresponding lighting module 6a, 6b, 6c during a step 206. Following step 206, the measured voltage is compared to the first voltage threshold S1 during a step 208. If the voltage measured during step 208 is below the first voltage threshold S1, the injection step 200 is repeated.

If, during step 208, the measured voltage is greater than or equal to the first voltage threshold S1, then, during step 210, the inversion means 54 command the inversion of the polarity of the corresponding lighting module 6a, 6b, 6c.

Furthermore, following step 210, the detection device 22 verifies, during a step 212, whether the voltage measured by the first corresponding measuring device 18 is greater than or equal to the first voltage threshold S1 for the direct and inverse polarities of the lighting module 6a, 6b, 6c.

If the voltage measured by the first corresponding measuring device 18 is below the first voltage threshold S1 for one of the direct and inverse polarities of the lighting module 6a, 6b, 6c, then the injection step 200 is repeated.

If the voltage measured by the first corresponding measuring device 18 is greater than or equal to the first voltage threshold S1 both for the direct polarity and the inverse polarity of the lighting module 6a, 6b, 6c, then, during a step 213, the first comparison software 52 increments the first voltage threshold S1 by the reference value, for the next comparison(s) done in step 208 for the corresponding lighting module 6a, 6b, 6c.

If, during step 204, the measured intensity is greater than or equal to the current threshold A1, during the step 214, the first measuring device 18 measures the voltage delivered to the corresponding lighting module 6a, 6b, 6c and that value is stored by the storage software 60. Next, during step 216, the connection direction, i.e., the direct polarity of the corresponding lighting module 6a, 6b, 6c, is detected. In fact, a non-zero current greater than the current threshold A1 crosses through the corresponding lighting module 6a, 6b, 6c and its light-emitting diode(s) 12 are powered on and then light around them.

Lastly, following step 216, an ending step 218, i.e., stopping the algorithm for the corresponding lighting module 6a, 6b, 6c, is carried out.

Thus, the connection direction of each lighting module 6a, 6b, 6c is determined for the direct and inverse polarities while limiting the voltage applied across the terminals of the lighting modules 6a, 6b, 6c to the first voltage threshold S1. This makes it possible to avoid the destruction of the light-emitting diode(s) 12 of each lighting module 6a, 6b, 6c, when looking for the connection direction of each lighting module 6a, 6b, 6c. The power supply system 8 in particular makes it possible to avoid applying a voltage to each lighting module that could lead to the destruction of its light-emitting diode(s) 12. Incrementing the first voltage threshold S1 with a pitch corresponding to the reference value makes it possible to increase the voltage applied to the corresponding lighting module 6a, 6b, 6c little by little, without any risk of destroying the lighting module 6a, 6b, 6c.

Additionally, when, following the incrementation step 213, the first incremented voltage threshold has a value greater than or equal to the maximum voltage, the search for the polarity is stopped, and the detection device 22 detects an open circuit. More specifically, the detection device 22 detects that no lighting module 6a, 6b, 6c is connected on the corresponding electrical connection 16a, 16b, 16c.

Also additionally, during step 213, the value of the second voltage threshold S2 is also incremented by the reference value.

Also additionally, following the measuring steps 206, 214, the detection device 22 performs a step, not shown, for comparing the measured voltage with a third voltage threshold S3. The third voltage threshold S3 is for example comprised between 0.3 V and 2.5 V. Following this step for comparison with the third voltage threshold S3, if the measured voltage is below the third voltage threshold S3, then the detection device 22 detects an error and tells the operator, via the control member 24 and the configuration module 10, that he must change the corresponding lighting module 6a, 6b, 6c.

Also additionally, if, following the comparison step with the third voltage threshold, the measured voltage is below the third voltage threshold S3 both for the direct polarity and the inverse polarity, a short-circuit is detected.

Also additionally, following the comparison step with the third voltage threshold, the detection device 22 performs a step for comparing the measured voltage with a fourth voltage threshold S4, for example, comprised between 2.5 V and 3 V. If, during the comparison step with the fourth voltage threshold S4, the measured voltage is comprised between the third voltage threshold S3 and the fourth voltage threshold S4, then the presence of a protection diode in the corresponding lighting module 6a, 6b, 6c to protect the light-emitting diodes 12 from overvoltages is detected. Furthermore, if the measured voltage is comprised between the third voltage threshold S3 and the fourth voltage threshold S4 for the direct and inverse polarities, then an error is detected and the detection device 22 indicates to the operator, via the control member and the configuration module 10, that the corresponding lighting module 6a, 6b, 6c must be changed.

According to the second embodiment of the power supply method, shown in FIG. 4, the method comprises a first step 300 consisting of connecting the lighting modules 6a, 6b, 6c to each corresponding electrical connection 16a, 16b, 16c. Next, during a step 302, the configuration file is stored in the configuration module 10.

Then, during a step 304, the control member 24 commands the electrical power supply 14, in order to deliver electricity successively on each electrical connection 16a, 16b, 16c. Additionally, each electrical connection 16a, 16b, 16c is supplied with the setpoint current and the minimum operating voltage is recorded during step 214.

Next, during step 306, the position and the electrical connection 16a, 16b, 16c associated with the corresponding lighting module 6a, 6b, 6c are identified after the operator identifies the lighting module 6a, 6b, 6c whereof the light-emitting diodes are powered on and that are then lighting around themselves. During step 306, the identification means 66 identify the electrical connection that was powered on during step 304.

Next, during step 308, the configuration parameters corresponding to the lighting module 6a, 6b, 6c identified by the operator are downloaded onto the control member 24 from the second downloading software 78.

Then, during a step 310, the first downloading software 66 downloads the configuration parameters downloaded during step 308 onto the electrical connection 16a, 16b, 16c identified in step 306, and more specifically onto the corresponding steering module 30.

The second embodiment makes it possible to connect each lighting module 6a, 6b, 6c randomly to one of the electrical connections 16a, 16b, 16c. In fact, owing to the successive power supply of the various lighting modules, the identification software 64 and the first 66 and second 78 downloading software applications make it possible to determine which lighting module 6a, 6b, 6c is associated with which electrical connection 16a, 16b, 16c, and to download the configuration parameters associated with the corresponding lighting module 6a, 6b, 6c onto the steering module 30 of the corresponding electrical connection 16a, 16b, 16c.

Furthermore, the second embodiment allows the operator to verify the position of each lighting module 6a, 6b, 6c in a room.

A third embodiment of the power supply method is shown in FIG. 5. In the third embodiment, a first step 400 consists of using a control member 24 to record the maximum power delivered by the power supply 14.

Then, during a following step 402, the first 18 and second 20 measuring devices measure the voltage and the current on each electrical connection 16a, 16b, 16c.

During a step 404, each first computation software 28 computes the power consumed by each electrical connection 16a, 16b, 16c. Next, during a step 406, the second computation software 68 determines the remaining available power based on the maximum power of the power supply 14 and the power supplies computed in step 404.

Lastly, during a step 408, the allocation software 70 allocates the available remaining power computed in step 406 to each electrical connection 16a, 16b, 16c.

Thus, in the context of the installation and successive connection of the lighting modules 6a, 6b, 6c to the various electrical connections 16a, 16b, 16c, the control member 24 indicates to the operator, via the configuration module 10, the remaining available power to be allocated to the electrical connections 16a, 16b, 16c not yet connected to a lighting module 6a, 6b, 6c.

Also alternatively, the control member 24 backs up allocation strategies comprising information relative to the power to be allocated to each electrical connection 16a, 16b, 16c and applies said strategies via the allocation software 70.

Also additionally, the operator sends, via the configuration module 10, a load shedding order associated with a lighting module 6a, 6b, 6c and an electrical connection 16a, 16b, 16c and the allocation software 70 reduces the power allocated to said electrical connection 16a, 16b, 16c and allocates the remaining electrical power to the other electrical connections 16a, 16b, 16c.

One skilled in the art will understand that the technical features of the embodiments described above can be combined with each other.

Additionally, the electrical power supply system 8 comprises a single detection device 22 and a single first computation software application 28 able to respectively carry out the detection and the computation of the instantaneous power consumed for each electrical connection 16a, 16b, 16c.

The third embodiment allows a dynamic allocation of the power to the different electrical connections 16a, 16b, 16c and the determination, during the successive connection of the lighting modules 6a, 6b, 6c on the electrical connections 16a, 16b, 16c, of the available remaining power and therefore of the type and rated power of the lighting modules that can be subsequently connected.

Furthermore, having a centralized allocation software 70 for all of the electrical connections 16a, 16b, 16c makes it possible to calibrate each steering module 30 and each electrical connection 16a, 16b, 16c, based on the maximum electrical power intended to be associated therewith.

Lastly, the third embodiment allows the management of a load shedding order for en electrical power, i.e., the management of a decrease in the power allocated to one of the electrical connections 16a, 16b, 16c.

In the first embodiment described above, the reference value is for example equal to 5 V and the maximum voltage Umax is for example 10 times greater than the reference value.

1. A power supply system for one or more lighting modules with light-emitting diodes, the or each lighting module comprising at least one light-emitting diode and being able to be polarized depending on its connection direction according to a direct polarity or an inverse polarity, the light-emitting diode(s) being polarized in direct mode for the direct polarity of the lighting module and in inverse mode, respectively, for the inverse polarity of the lighting module,
the system including:
an electrical power source able to be connected to the or each lighting module via an electrical connection for the or each lighting module,
a first measuring device for measuring, on the or each electrical connection, a voltage delivered to the corresponding lighting module and a second measuring device for measuring, on the or each electrical connection, a current delivered to the corresponding lighting module,
a detection device for detecting a connection direction of the or each lighting module comprising, for the or each lighting module, injection means for injecting a setpoint current on the corresponding electrical connection, first comparison means for comparing with a first voltage threshold, the voltage measured on the corresponding electrical connection following the injection of the setpoint current and inversion means for inverting the polarity of the lighting module when the voltage measured on the corresponding electrical connection is greater than or equal to the first voltage threshold,
wherein when the voltage measured on the corresponding electrical connection is greater than or equal to the first voltage threshold for the direct and inverse polarities of the lighting module, the first comparison means are capable of incrementing the first voltage threshold by a reference value for one or more future comparisons of said voltage with the first voltage threshold.

2. The system according to claim 1, wherein the detection device comprises, for the or each lighting module, second comparison means for comparing the intensity of the current measured on the corresponding electrical connection with a current threshold, the second comparison means being able to detect the direct polarity of the lighting module when the measured intensity is above the current threshold.

3. The system according to claim 1, wherein for the or each lighting module, the injection means are able, upon each change in polarity of the lighting module, to inject the setpoint current in order to increasingly vary the voltage delivered to the lighting module, between a second voltage threshold and a maximum voltage, the value of the first voltage threshold being comprised between that of the second voltage threshold and that of the maximum voltage.

4. The system according to claim 1, wherein the detection device comprises storage means for the or each lighting module, for storing a value of the voltage measured by the first measuring device, when the intensity of the current measured by the second measuring device is greater than the current threshold, the stored value corresponding to a minimum operating voltage of the corresponding lighting module.

5. A lighting assembly with light-emitting diodes including one or more lighting modules with light-emitting diodes and a power supply system for the lighting modules, wherein the power supply system is according to claim 1.

6. The assembly according to claim 5, wherein it comprises several lighting modules, and wherein the power supply system comprises a control member for the electrical power supply capable of successively powering each electrical connection, the control member comprising identification means for the electrical connection associated with each lighting module.

7. The assembly according to claim 6, wherein it further comprises a configuration module for the power supply system, the configuration module comprising means for backing up a configuration file, the configuration file including configuration parameters for each lighting module, and wherein following the identification of each electrical connection, the configuration module is able to download the configuration parameters into the control member and associate them with the corresponding electrical connection.

8. The assembly according to claim 6, wherein for each lighting module, the power supply system comprises first computation means for computing an instantaneous consumed power, wherein the first computation means are able to send the control member the instantaneous powers computed for each electrical connection, and wherein the control member comprises a second computation means for computing a remaining available power based on the instantaneous consumed powers, and allocation means for allocating power to the various electrical connections.

9. The assembly according to claim 7, wherein for each lighting module, the power supply system comprises first computation means for computing an instantaneous consumed power, wherein the first computation means are able to send the control member the instantaneous powers computed for each electrical connection, and wherein the control member comprises a second computation means for computing a remaining available power based on the instantaneous consumed powers, and allocation means for allocating power to the various electrical connections.

10. A power supply method for one or more lighting modules with light-emitting diodes using a power supply system, the or each lighting module comprising at least one light-emitting diode and being able to be polarized using a direct polarity or an inverse polarity depending on its connection direction, the light-emitting diodes(s) being polarized in direct mode for the direct polarity of the lighting module, and in inverse mode, respectively, for the inverse polarity of the lighting module, the system including an electrical power supply able to be connected to the or each lighting module via an electrical connection for the or each lighting module, a first measuring device for measuring a voltage delivered to the corresponding lighting module on the or each electrical connection, a second measuring device for measuring a current delivered to the corresponding lighting module on the or each electrical connection, and a detection device for detecting a connection direction of the or each lighting module,
the method comprising, for the or each lighting module, the following steps:
a) using the detection device to inject a setpoint current on the corresponding electrical connection,
b) measuring the voltage delivered to the lighting module,
c) comparing the measured voltage with a first voltage threshold, during the measuring step,
d) inverting the polarity of the corresponding lighting module, when the voltage measured on the corresponding electrical connection is greater than or equal to the first threshold voltage, and returning to the injection step,
wherein the method further comprises, for the or each lighting module, the following step:
e) when said voltage is greater than or equal to the first voltage threshold for the direct and inverse polarities of the lighting module, incrementing the first voltage threshold by a reference value, for one or more future comparisons of the voltage measured on the corresponding electrical connection with the first voltage threshold.

11. The method according to claim 10, wherein for the or each lighting module, the method comprises the following steps before the step for measuring the voltage:
a1) measuring the current circulating in the corresponding electrical connection,
